(19) United States
(12) Patent Application Publication
(10) Pub. No.: US 2016/0033659 A1
(43) Pub. Date: Feb. 4, 2016

(54) HIGH PERFORMANCE COMPUTING FOR THREE DIMENSIONAL PROTON COMPUTED TOMOGRAPHY

(71) Applicants: BOARD OF TRUSTEES OF NORTHERN ILLINOIS UNIVERSITY, Dekalb, IL (US); FERMI RESEARCH ALLIANCE, LLC, Batavia, IL (US)

(72) Inventors: George Coutrakon, Redlands, CA (US); Paul Rubinov, Batavia, IL (US); Vishnu Zutshi, Dekalb, IL (US); Alexandre S. Dychkant, Dekalb, IL (US); Bela Erdelyi, Romeoville, IL (US); Victor Rykalin, Aurora, IL (US); Sergey Uzunyan, Dekalb, IL (US); Greg Selberg, Batavia, IL (US); John Rauch, Batavia, IL (US); Peter Wilson, Batavia, IL (US)

(21) Appl. No.: 14/811,046

(22) Filed: Jul. 28, 2015

Related U.S. Application Data
(60) Provisional application No. 62/030,403, filed on Jul. 29, 2014.

(51) Int. Cl. G01T 1/24; G01T 1/161

(52) U.S. Cl. CPC G01T 1/248; G01T 1/161

(57) ABSTRACT

A high performance computer system for three dimensional proton computed tomography and method of imaging an object are disclosed. The system includes a proton computed tomography (pCT) detector assembly with an arrangement of fibers attached to silicon photo multipliers (SiPMs). An electronic circuit amplifies and digitizes signals received from the SiPMs and communicates the digitized data over a network for image reconstruction.

### RELATED APPLICATIONS

This application claims the benefit of U.S. Provisional Application No. 62/030,403, filed Jul. 29, 2014, which is hereby incorporated by reference in its entirety.

### BACKGROUND AND SUMMARY

This disclosure relates generally to CT scanners; in particular, this disclosure relates to a proton-computed tomography device.

Existing treatment planning systems at proton therapy centers use x-ray CT as the primary imaging modality for treatment planning to calculate doses to tumor and healthy tissues. One limitation of x-ray CT is in the conversion of x-ray attenuation coefficients to relative (proton) stopping powers, or RSP. This results in more proton range uncertainty, larger target volumes and therefore, more dosage to healthy tissues. Therefore, there exists a need for a novel device for imaging and reconstructing more accurate RSP values.

According to one aspect, this disclosure provides a high performance computer system for three dimensional proton computed tomography. The system includes a proton computed tomography (pCT) detector assembly with an arrangement of fibers attached to silicon photo multipliers (SiPMs), the SiPMs generating signals representative of proton energy detected by the arrangement of fibers. An electronic circuit is provided that is in electrical communication with the SiPMs of the pCT detector system. In some embodiments, the electronic circuit includes an amplifier, a digitizer, a network communication device and a processor. The amplifier is configured to amplify the signals of the SiPMs. The digitizer is configured to digitize the signals of the SiPMs. The network communication device transmits messages over a network. The processor controls amplifying and digitizing of the signals of the SiPMs and is configured to send packetized messages with data of the SiPMs using the network communication device. In some embodiments, the system includes a data acquisition system in electronic communication with the electronic circuit for storing data received from the electronic circuit.

According to another aspect, this disclosure provides a method of imaging an object. The method includes the step of providing a proton computed tomography (pCT) detector assembly including an arrangement of fibers attached to silicon photo multipliers (SiPMs). Each of the SiPMs generate a signal representative of proton energy detected by one or more of the fibers. The signals of a plurality of SiPMs are amplified and digitized with an electronic circuit and sent in packetized messages via a network for image reconstruction.

Additional features and advantages of the disclosure will become apparent to those skilled in the art upon consideration of the following detailed description of the illustrated embodiment exemplifying the best mode of carrying out the invention as presently perceived. It is intended that all such additional features and advantages be included within this description and be within the scope of the disclosure.

### BRIEF DESCRIPTION OF THE DRAWINGS

The present disclosure will be described hereafter with reference to the attached drawings which are given as non-limiting examples only, in which:

FIG. 1 is a diagrammical view of a proton CT imaging system according to an embodiment of this disclosure.

FIG. 2 is a side view of an example of fiber configuration according to an embodiment of this disclosure.

FIG. 3A shows an example of an (X,Y) fiber tracker station according to an embodiment of this disclosure.

FIG. 3B shows an example of an arrangement of fibers attached to silicon photo multipliers (SiPMs) according to an embodiment of this disclosure.

FIG. 4A is a graph showing an example of pedestal and single photoelectron noise signal peaks for a single calorimeter tile.

FIG. 4B is a graph showing an example of ADC distribution as a function of file number for 200 MeV protons.

FIG. 4C is a graph showing an example of photo-electron count per fiber tracker bundle for 200 MeV protons.

FIG. 5 is a diagrammatic view of an example of front end electronics that could be used for amplifying, digitizing and storing data before sending to the data acquisition system according to an embodiment of this disclosure.

FIG. 6 is a diagrammatic view of an example of a data acquisition system according to an embodiment of this disclosure.

FIG. 7 is a photograph of an example of a proton CT scanner according to an embodiment of this disclosure.

Corresponding reference characters indicate corresponding parts throughout the several views. The components in the figures are not necessarily to scale, emphasis instead being placed upon illustrating the principals of the disclosure. The exemplification set out herein illustrates embodiments of the disclosure, and such exemplification is not to be construed as limiting the scope of the disclosure in any manner.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

This disclosure relates to a proton CT scanner for applications in proton treatment planning. In proton therapy, the current treatment planning systems are based on X-ray CT images that have intrinsic limitations in terms of dose accuracy to tumor volumes and nearby critical structures. Proton CT aims to overcome these limitations by determining more accurate relative proton stopping powers directly as a result of imaging with protons. At present, the proton RSPs for various tissues, as derived from X-ray CT, produce range uncertainties (Schneider, 1994) of about 3 to 4%. This disclosure attempts to reduce this to approximately 1% of the total range using proton CT. In addition, three to five times lower doses than X-ray CT are possible and absence of artifacts from high density dental or other implants will add to higher quality images. The proton CT imaging requires reconstruction of the individual proton tracks and their energy losses in the scanned volume. The number of protons to acquire for the head-size volume scan is of order one billion. To finish scan in a time acceptable for the patients the track collection rate should be of order 2 MHz, that requires fast tracker and energy detectors. To date two proton CT scanners are under development in the United States. The system that uses silicon strip technology for the tracker planes and five plastic scintillators for the range measurements was built in the Santa Cruz Institute of Particle Physics and is undergoing testing at Loma Linda University Medical Center (Sadrozinski, 2013).

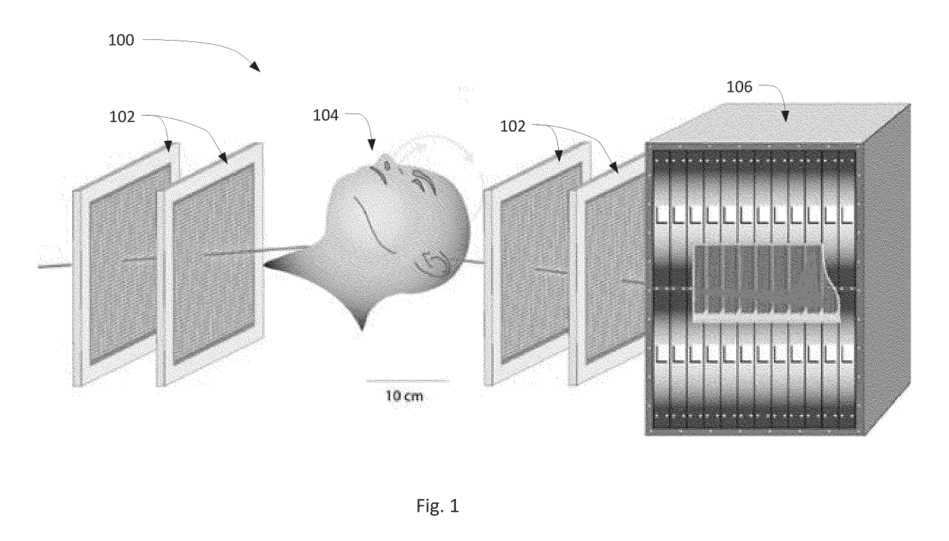

A proton CT scanner based on fiber tracker and scintillator stack range detector that has been developed at Northern Illinois University in conjunction with FNAL in Batavia, Ill. For example, U.S. Pat. No. 8,766,180 for a High Performance Computing For Three Dimensional Proton Computed Tomography (HPC-PCT), which is hereby incorporated by reference, describes example device. FIG. 1 shows a schematic of a proton CT scanner 100. In the illustrative example shown, the system 100 includes eight planes of tracking detectors 102; two X and two Y coordinate measurements both before and after the patient 104. This provides the information for finding the trajectory through the head 104 to correct, as much as possible, for multiple coulomb scattering in the patient 104. A “most likely path” formalism (Erdelyi, 2009) is used to find which voxels, of order 1 mm³ are crossed by every track. In addition, a calorimeter 106 having a stack of thin scintillator tiles is used to determine the water equivalent path length (WEPL) of each track through the head 104. The X-Y coordinates and WEPL are required input for image reconstruction software to find RSP values of each voxel in the head 104 and generate corresponding 3D image.

1. Design Specification

In addition to a high data rate of 2 MHz, large enough area should be covered to image an adult human head so that table motion is not required or that splice data from multiple scans are not required to make an image long enough along the body axis. For head scans, in one embodiment, a maximum head size of 23 cm diameter and a length along the body axis of 20 cm were chosen. This will allow imaging of the head 104 down to the jaw bone in one 360° gantry rotation. A fixed incident proton beam energy of 200 MeV with a range of 26 cm in water can be used for head size imaging. This proton CT detector is compatible with the geometric constraints of most proton treatment nozzles and patient positioners. Beam spreading from an effective source in the nozzle sets the detector sizes required for cone beam geometry. Multiple coulomb scattering in the tracking detectors requires a reduction of the mass of the detectors as much as possible. For this reason, each tracking plane has a water equivalent thickness less than 1 mm.

2. Detector Design and Construction

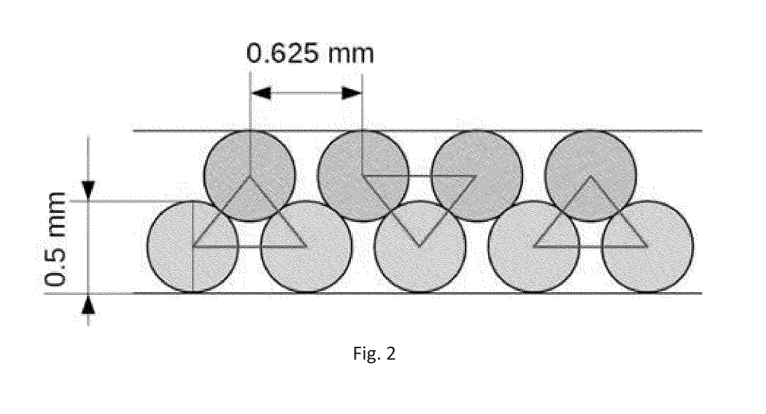

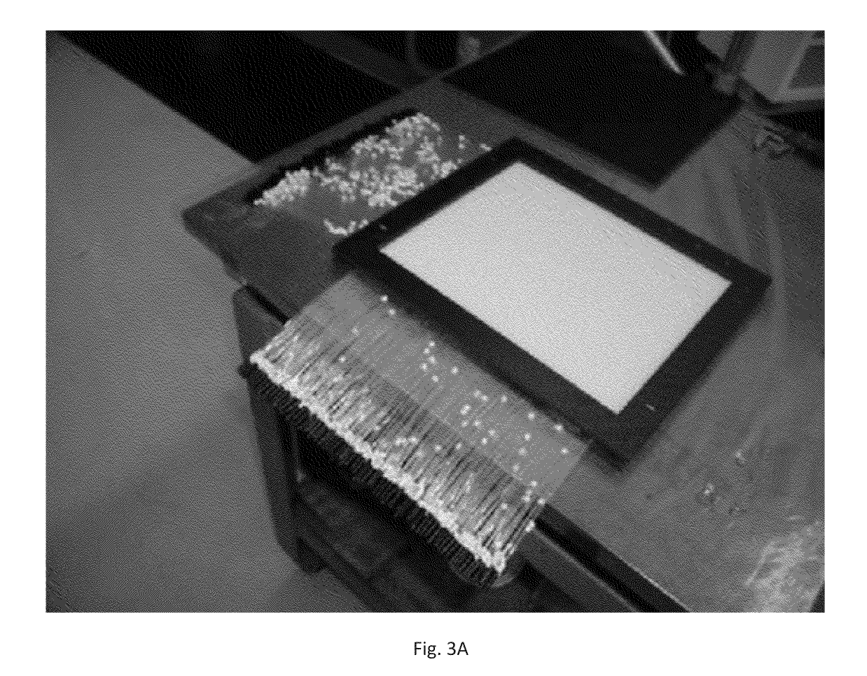

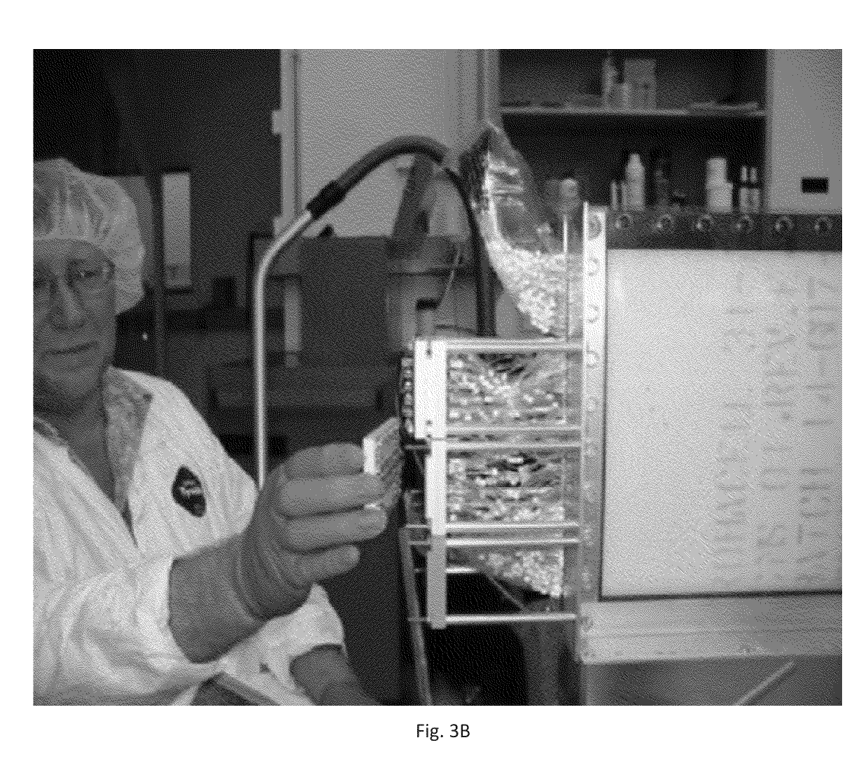

In order to have low mass detectors, with high proton rates, and continuous area coverage over a large area, the tracker was constructed from 0.5 mm diameter polystyrene scintillating fibers by Kuraray (KurarayCo.). In one embodiment, fibers were initially cut to 50 cm length, then laid flat, and doubled layered (see, e.g., FIG. 2) on a low density, 0.03 g/cm3, 2 mm thick rohocell substrate with machined grooves and glued to hold the fibers in place with close spacing to avoid gaps in detecting passing protons. The entire assembly is supported on carbon fiber frames. A photograph of one tracker plane, 20×24 cm, is shown in FIG. 3A for purposes of example.

In the illustrative embodiment shown, fibers are grouped in triplets, called bundles, according to FIG. 2, which give a pitch between bundles of 0.94 mm. Each bundle is readout into silicon photo multipliers (SiPMs), produced by CPTA (CPTA Ltd.) which are mounted on Techtron blocks that connect each of them to a fiber triplet. The SiPMs chosen have the best chromatic (or wavelength) match to the Kuraray scintillators. One end of each fiber is polished and mirrored. The other end is polished and mechanically pressed to a SiPM on a block shown in FIG. 3B. The rms spatial resolution of each tracker plane is given by the pitch divided by \sqrt{12}, or 0.27 mm. The integrated water equivalent thickness (WET) of each tracker along the beam direction is less than 1 mm. With four planes of 20×24 cm² in area and four planes with 24×30 cm² in area, there are about 2100 channels of readout for the entire tracker.

In one illustrative embodiment, the calorimeter 106 chosen for this design is a proton range detector which includes a stack of 96, 3.2 mm thick, polyvinyltoluene (PVT) scintillating tiles, with 0.006 mm aluminized mylar between adjacent tiles. Each tile, 27×36 cm² in area, is machine grooved to embed a 1.2 mm diameter wavelength shifting (WLS) fiber that weaves four times across the tile for improved light collection efficiency. Both ends of the WLS fiber are read out through SiPMs. This requires 192 channels of readout for the calorimeter. Each SiPM signal is amplified and digitized for later analysis for fitting to the shape of a Bragg peak to determine the proton range in the calorimeter. Water equivalent blocks can be used to calibrate range measured in calorimeter (Hurley, 2012).

An intrinsic limitation in any proton calorimeter is the combined range (or energy) straggling due to the mass represented by the patient plus calorimeter. In near water equivalent materials such as brain tissue and PVT scintillator, the sum of energy straggling in the human head and calorimeter is almost constant and approximately equal to ±3.6 mm (Janni, 1982). Therefore, there is little incentive to produce tiles less than 3 mm thickness.

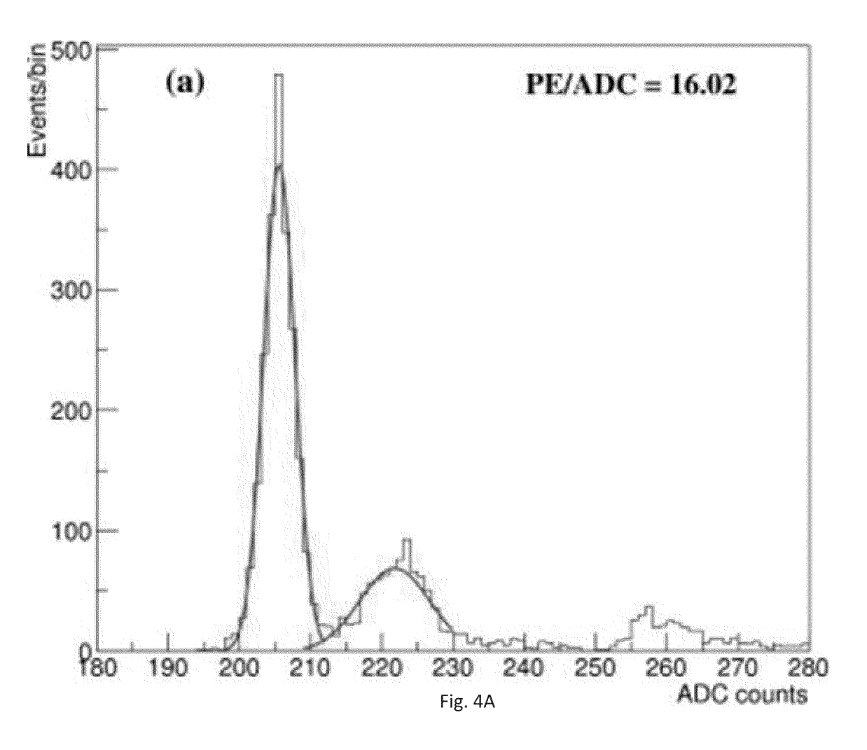

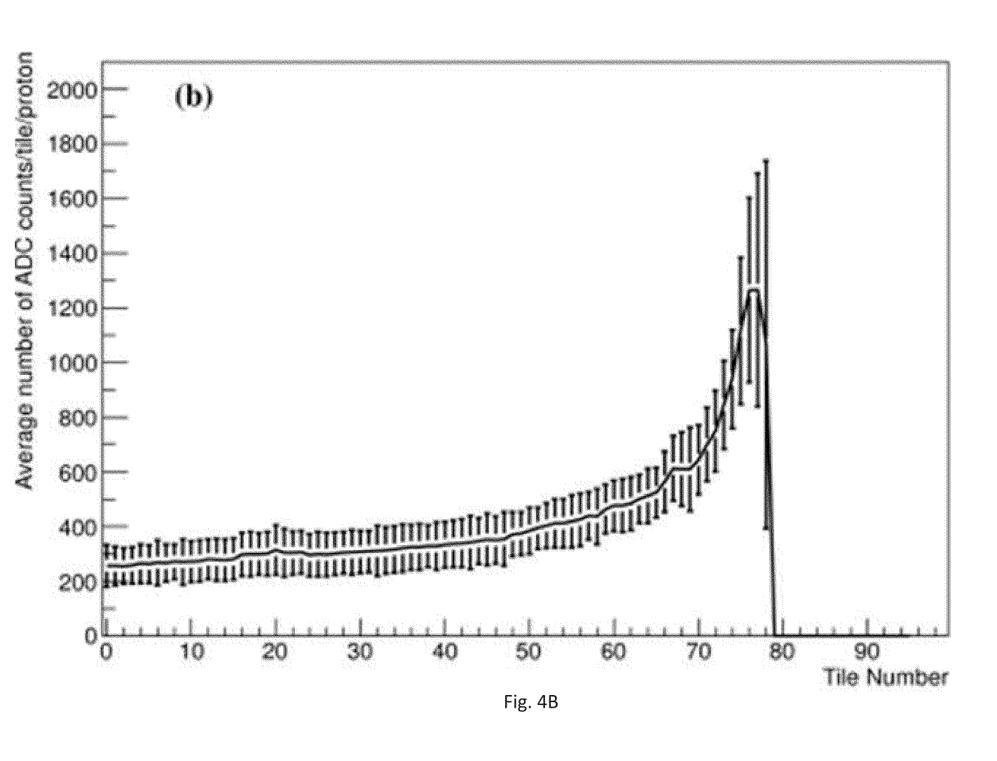

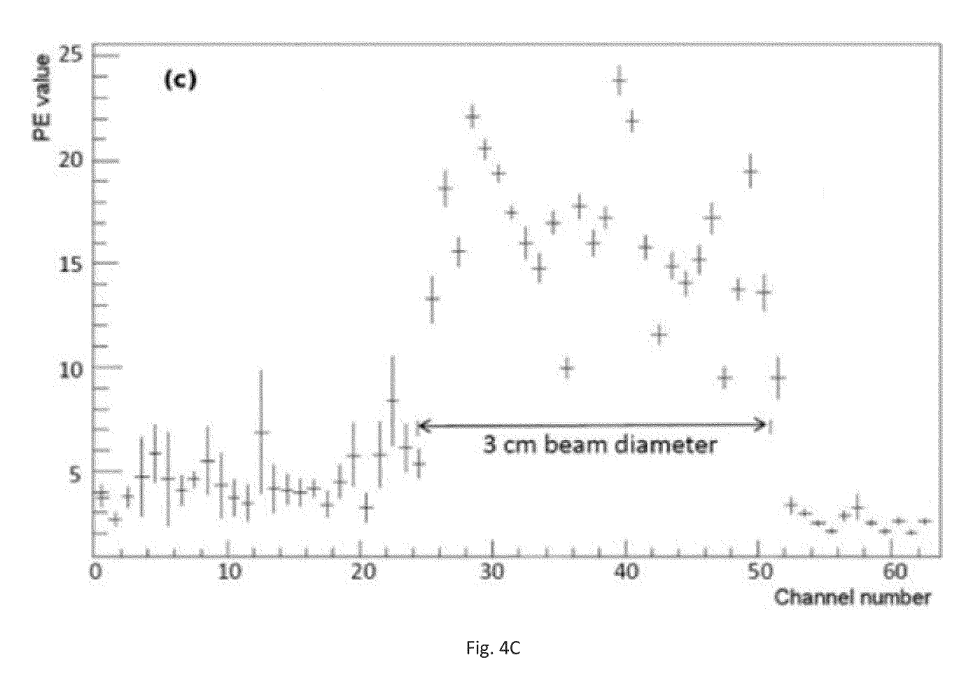

The 96 tile calorimeter was built and underwent first tests with 200 MeV proton beam at Central DuPage Hospital in Warrenville, Ill. Examples of pedestal distribution and a single photoelectron distribution from a calorimeter tile are shown in FIG. 4A. FIG. 4B shows the Bragg peak from a sample of 200 MeV protons. To measure signal to noise ratio of the fiber bundles a fiber tracker plane prototype was also exposed to a 200 MeV proton beam. The results are shown in FIG. 4C, with 15 to 20 photo-electrons per proton per channel in the beam spot area.

3. Electronics

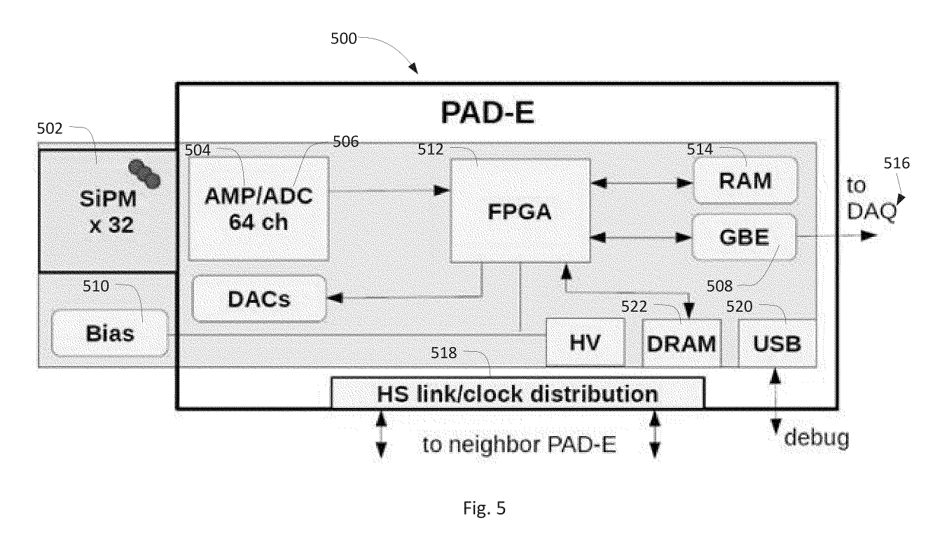

In the embodiment shown in FIG. 5, the electronics that read out the SiPMs 502 include a custom circuit board 500 with preamplifiers 504, digitizers 506, and ethernet readout 508. In one illustrative embodiment, this custom board uses commercial off-the-shelf (COTS) components to provide readout for up to 32 channels of SiPM in a 220 mm×100 mm format that fits into a standard 3 U sub-rack. The same board 500 is used for readout of the trackers 102 and the calorimeter 106. The digitization of the signals from SiPMs, after appropriate amplification and shaping, is illustratively 12 bits per channel at 75 MSPS. The board 500 is completely self-contained and generates the bias 510 for the SiPMs (one bulk voltage but with a 3 V adjustment range for each SiPM). It also contains an FPGA 512 for processing all of the data generated by the SiPMs, memory 514 for buffering up to 128 MB of data and a gigabit ethernet interface 508 for pushing data directly to the data acquisition (DAQ) system 516. Other support circuitry includes temperature sensors for the SiPMs, clock management 518 and a high speed USB port 520 for debugging. Parameters such as the board's ethernet address or the correct bias voltage for the SiPMs are stored in a small flash memory 522 on the board. The board 500 is illustratively powered by a single 5 V power supply and has a power consumption of up to 15 W for 32 SiPM electronics channels. Each board locks to the clock provided by one board in each of the 9 sub-racks. Each of these boards in turn locks to a “master” board which has a free running crystal clock. Run control is accomplished by communicating with this “master” over ethernet.

The scanner is “self triggered” in the sense that any channel with a signal above threshold will be time stamped and stored in a local buffer for readout. A synchronous signal allows all boards to provide a timestamp that is used by the DAQ system to associate the data from different parts of the detector for a single proton history. Data from signals in the detector is highly compressed (only fiber address and timestamp from the trackers, compressed amplitude and time stamp from the calorimeter) and sent to the DAQ as soon as it is available. A synchronization signal which circulates across all boards approximately once per millisecond initiates a packet or “frame” of data readout from memory 512 to DAQ memory via 1 Gbit/s ethernet with only slight dead time penalty. A “footer” with error messages can be sent with each packet as well. Organizing the data into these one millisecond “time frames” allows for a relatively small timestamp (16 bits of 75 MHz clock cycles) and allows the DAQ 516 to monitor the integrity of the data.

4. Data Acquisition System

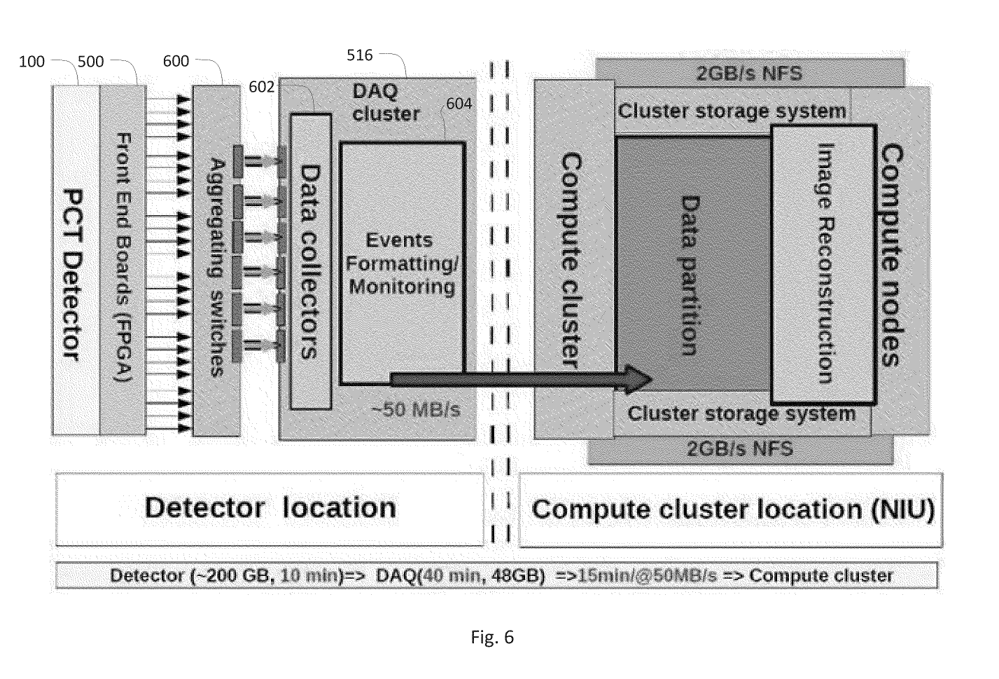

FIG. 6 shows an illustrative embodiment with a detector 100 in electronic communication with front end boards 500, which sends data to DAQ 516 via a plurality of aggregating switches 600 over Ethernet. The front end electronics 500 will illustratively send data to the DAQ 516 via 1 Gbit/s ethernet lines using UDP protocol. Each proton event contains data for 8 tracker planes and the 96 tile scintillator stack. Each event is calculated to generate about 25 bytes from the 8 hits on the 8 planes and about 75 bytes from the 96 tiles. For a 10 minute scan with 90 projection angles at a data rate of 2 million protons per second, we expect 200 MB/s written to RAM by 24 data collectors running on six interconnected Linux workstations. At the end of the scan, the back end DAQ 516 will write data to disk 602 and subsequently, through post processing of the data 604, obtain proton histories in the format for image reconstruction, i.e., 4 X and 4 Y coordinates, WEPL, and beam (or phantom) rotation angle.

5. Summary

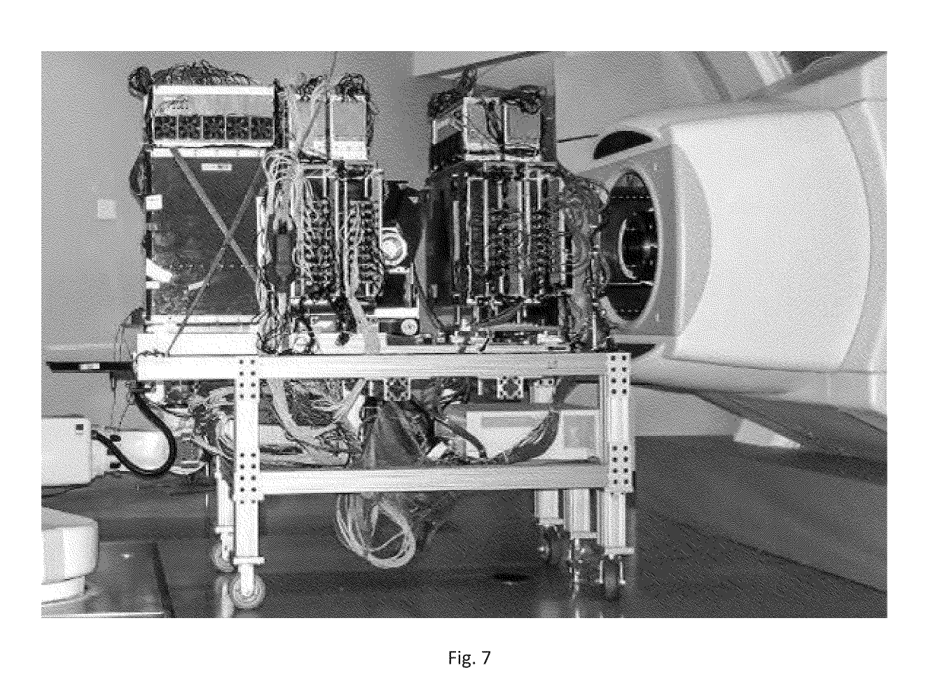

The NIU Phase II proton CT scanner is fully assembled and installed for tests in a 200 MeV proton beam in Warrenville, Ill., USA. FIG. 7 illustratively shows the scanner mounted on a cart in a treatment room. After system commissioning, a CIRS head phantom (Computerized Imaging Reference Systems, Inc.) will be inserted between tracker planes to collect data for image reconstruction on a CPU/GPU compute cluster (Duffin, 2012). This compute cluster has been tested with data acquired with an earlier prototype scanner (Coutrakon, 2011 and Sadrozinski, 2012) and has demonstrated high quality 3D image reconstruction of a 14 cm spherical Lucy phantom from Standard Imaging, Inc. (www.standardimaging.com). The first 3D head scan images are expected to be obtained in summer of 2014. The detailed project documentation can be found at (http://www.nicadd.niu.edu/research/medical).

### PUBLICATIONS

Publications cited in this application are herein incorporated by reference to the extent they relate materials or methods disclosed herein,
Computerized Imaging Reference Systems, Inc., www.cirsinc.com, Norfolk, Va.
Coutrakon, G. et al., “Design and Construction of the 1st Proton CT Scanner”, AIP Conference Proceedings, No. 1525, Application of Accelerators in Research and Industry, Ft. Worth, Tex., August 2012, p. 327-331.
CPTA Ltd., www.cpta-apd.ru, Moscow, Russia.
Duffin, K. et al., “An analysis of a distributed GPU implementation of proton computed tomographic reconstruction”, Proceedings of the 2012 SC Companion: HPC, networking, storage and analysis, p. 166-175, ISBN no. 978-0-7695-4956-9, November 2012, Seattle, Wash.
Erdelyi, B., “A comprehensive study of the most likely path formalism for proton computed tomography”, Physics in Medicine and Biology 54, p. 6095 (2009).
Hurley, R. F. et al., “Water equivalent path length calibration of a prototype CT scanner”, Med. Phys. 39 (5), p. 2438 (2012).
Janni, J., “Proton range-energy tables, 1 keV-10 GeV,” Atomic Data and Nuclear Data Tables 27(2-5), p. 147-429 (1982).
KurarayCo., Ltd, Japan, http://kuraraypsf.jp/psf/index.html
Sadrozinski, H. F. W. et al., “Development of a head scanner for proton CT”, Nucl. Instrum. Meth. A699, 205-210 (2013).
Sadrozinski, H. F. W. et al., IEEE NSS-MIC Conference, 4457-4461, (2011).
Schneider, U., “Proton Radiography as a tool for quality control in proton Therapy”, Med. Phys. 22, p. 353 (1994).
Uzunyan, S. et al., “Development of a proton Computed Tomography (pCT) scanner at NIU”, Proceedings of the New Trends in High-Energy Physics, p. 152-157, Alushta, Crimea, Ukraine, September 2013, arXiv:1312.3977 (2013).
http://www.nicadd.niu.edu/recearch/medical
http://www.standardimagingcom, see Lucy 3D QA phantom, Middleton, Wis. 53562.

1. A high performance computer system for three dimensional proton computed tomography:
a proton computed tomography (pCT) detector assembly including an arrangement of fibers attached to silicon photo multipliers (SiPMs), the silicon photo multipliers generating signals representative of proton energy detected by the arrangement of fibers;
an electronic circuit in electrical communication with the SiPMs of the pCT detector system, the electronic circuit including:
an amplifier configured to amplify the signals of the SiPMs;
a digitizer configured to digitize the signals of the SiPMs;
a network communication device configured to transmit messages over a network.
a processor configured to control amplifying and digitizing of the signals of the SiPMs, the processor configured to send packetized messages with data of the SiPMs using the network communication device;
a data acquisition system in electronic communication with the electronic circuit, the data acquisition system configured to store data received from the electronic circuit.

2. The system of claim 1, wherein the electronic circuit is configured to electronically communicate with a plurality of channels of SiPMs

3. The system of claim 2, wherein the electronic circuit is configured to communicate with up to approximately 32 channels of SiPMs.

4. The system of claim 1, wherein the pCT detector assembly includes tracking detectors with a plurality of SiPMs and a calorimeter with a plurality of SiPMs, wherein the electronic circuit is configured to be electronically connected to the SiPMs of both detectors and calorimeter.

5. The system of claim 1, wherein the electronic circuit is configured to generate bias voltage for SiPMs.

6. The system of claim 5, wherein the bias voltage includes an approximately 3V adjustment range for each SiPM.

7. The system of claim 1, wherein the electronic circuit resides on a PCB board sized to fit a standard 3 U-sized server rack.

8. The system of claim 1, wherein the electronic circuit resides on a PCB board sized at approximately 220 mm×100 mm.

9. The system of claim 1, further comprising a plurality of the electronic circuits in electronic connection with each other, wherein each of the plurality of electronic circuits are connected with multiple channels of SiPMs of the pCT detector assembly and are configured to amplify, digitize and digitally communicate the signals of the SiPMs.

10. The system of claim 9, wherein each of the plurality of electronic circuits includes means for amplifying, digitizing and packetizing data from the SiPMs for communication in electronic messages.

11. The system of claim 9, wherein at least a portion of the plurality of electronic circuits are synchronized with each other.

12. A method of imaging an object, the method comprising the steps of:
providing a proton computed tomography (pCT) detector assembly including an arrangement of fibers attached to silicon photo multipliers (SiPMs), wherein each of the SiPMs generate a signal representative of proton energy detected by one or more of the fibers;
amplifying and digitizing the signals of a plurality of SiPMs with an electronic circuit; and
sending the digitized data in packetized messages via a network for image reconstruction.

13. The method of claim 12, wherein the electronic circuit is configured to electronically communicate with up to approximately 32 channels of SiPMs.

14. The method of claim 12, wherein the pCT detector assembly includes tracking detectors with a plurality of SiPMs and a calorimeter with a plurality of SiPMs, wherein the electronic circuit is configured to be electronically connected to the SiPMs of both detectors and calorimeter.

15. The method of claim 12, wherein the electronic circuit is configured to generate bias voltage for SiPMs.

16. The method of claim 15, wherein the bias voltage includes an approximately 3V adjustment range for each SiPM.

17. The method of claim 1, wherein the electronic circuit resides on a PCB board sized to fit a standard 3 U-sized server rack.

18. The method of claim 1, wherein the electronic circuit resides on a PCB board sized at approximately 220 mm×100 mm.

19. The method of claim 1, further comprising a plurality of the electronic circuits in electronic connection with each other, wherein each of the plurality of electronic circuits are connected with multiple channels of SiPMs of the pCT detector assembly and are configured to amplify, digitize and digitally communicate the signals of the SiPMs.

20. The method of claim 19, wherein at least a portion of the plurality of electronic circuits are synchronized with each other.
